(19) United States
(12) Patent Application Publication
(10) Pub. No.: US 2002/0104016 A1
(43) Pub. Date: Aug. 1, 2002

(54) Network router

(75) Inventors: Robert Fung-chen Pan, Apex, NC (US); Richard Jerome Morris, San Jose, CA (US); Bruce S. Campbell, Raleigh, NC (US)

Correspondence Address: IBM CORPORATION, 2Y7/B656, PO BOX 12195, RESEARCH TRIANGLE PARK, NC, 27709, US

(73) Assignee: International Business Machines Corporation, Armonk, NY (US)

(21) Appl. No.: 09/770,165

(22) Filed: Jan. 26, 2001

(51) Int. Cl. G06F 15/173

(52) U.S. Cl. 713/201; 709/238

(57) ABSTRACT

A network router for coupling a Local Area Network to a Wide Area Network such as the Internet or an intranet includes a smart card device for receiving and reading a smart card. The smart card will include information needed for permitting the router to access the Internet or intranet, such as an access phone number, an encryption key, configuration data, and an ID and password. A specified security level can also be stored within the information on the smart card to restrict such access.

### TECHNICAL FIELD

The present invention relates in general to networks, and in particular, to a network router.

### BACKGROUND INFORMATION

Routers are the central switching offices of the Internet and corporate intranet and WANs (Wide Area Networks). A router is an interface between two networks, which is protocol-sensitive, typically supporting multiple protocols, and most commonly operating at the bottom three layers of the OSI model, using the Physical, Link and Network Layers to provide addressing and switching. Routers also may operate at Layer 4, the Transport Layer, in order to ensure end-to-end reliability of data transferred.

Routers are now available even for Small Office/Home Office implementations, whereby a router is purchased by a small business or individual for connection between their LAN (Local Area Network) and a WAN, such as the Internet. One problem that often arises is that it is difficult for many such users to configure the router for accessing the WAN. Furthermore, a problem arises in that it is difficult for such users to implement and ensure network access security.

One solution to the foregoing problems may be the use of other storage media such as disk drives and portable FLASH memory modules, but such solutions are often cumbersome, expensive, difficult to install, and lack any means for implementing security features.

### SUMMARY OF THE INVENTION

The present invention addresses the foregoing needs by providing a network router for coupling a LAN to a WAN, which includes a smart card reader/writer coupled to the router hardware so that router configurations can be pre-programmed or re-programmed on the smart card and then easily installed into the router using a “plug and play” input. Additionally, security keys can be logged on the smart card for different levels of access. Also, an Internet Service Provider (ISP) can utilize a smart card for providing functions/utilities, collecting statistics, or billing purposes.

In one embodiment of the present invention, a smart card can be purchased with specific information pertaining to an ISP. The smart card is then inserted into the smart card device in the router, and the router will automatically dial and connect to the ISP using the configuration information stored on the smart card.

In another embodiment of the present invention, an employee can be given a pre-programmed smart card by the employer with the ISP access phone number, configuration data, encryption key, ID/password, security level and other necessary data. The employee can then use the smart card in a network router at the home office for dialing up and connecting to the ISP. Access to a particular security level can also be implemented.

In another alternative embodiment of the present invention, an Intranet access phone number, configuration data, encryptionkey, ID/password, security level, and other necessary data can be stored on a smart card, which can then be inserted into a router whereby the router will dial up and connect to the specified Intranet.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a network configured in accordance with the present invention;

FIG. 2 illustrates a process for using the smart card and router of FIG. 1 in accordance with one embodiment of the present invention;

FIG. 2 illustrates the use of the smart card and router of FIG. 1 in an alternative embodiment of the invention; and

FIG. 3 illustrates use of the smart card and router illustrated in FIG. 1 in another alternative embodiment of the present invention.

### DETAILED DESCRIPTION

In the following description, numerous specific details are set forth such as specific network topologies, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

A smart card is a credit card-sized card which contains electronics, including a microprocessor and a memory device. The card canbeused to store information thereon. Since smart cards are tamper resistant hardware devices that store private keys and other sensitive information, they can be used for security applications. The smart card of the present invention can be an I2C EEPROM smart card, available as part number X76F640Y from Xicor.

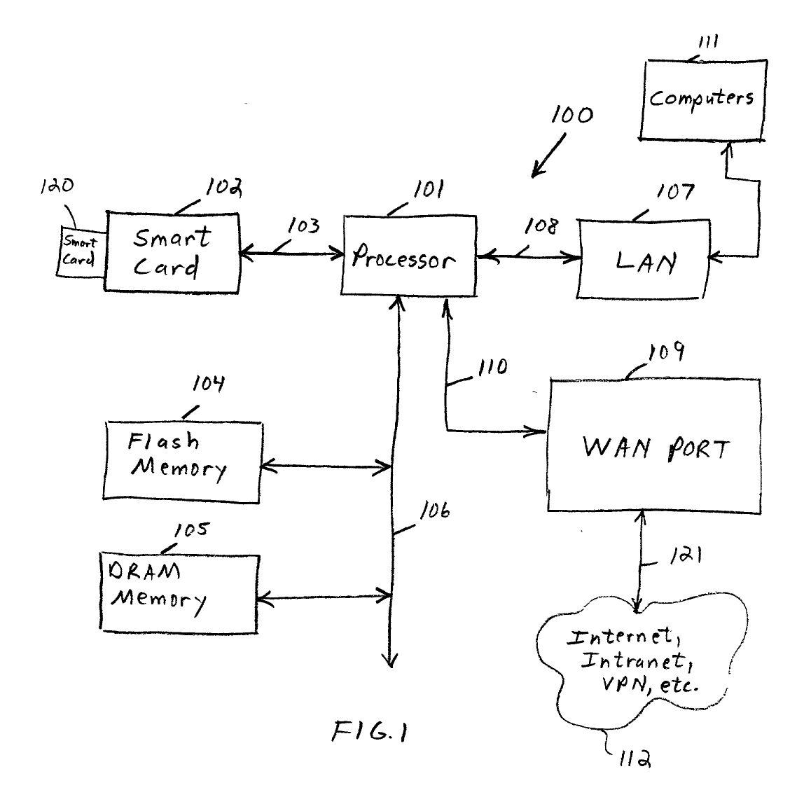

Referring to FIG. 1, there is illustrated a network router 100, that includes a processor 101 coupled by bus 106 to FLASH memory 104 and DRAM memory 105. The processor is coupled by bus 103 to a smart card device 102, which is operable for receiving a smart card 120. The FLASH memory 104 is a nonvolatile memory adaptable for storing compressed operational code, configuration data, diagnostic code, and other nonvolatile data. DRAM memory 105 is operable for storing execution code and other volatile data.

Processor 101 is coupled to LAN 107 and WAN port 109 by SCC (Serial Channel Communication) buses 108 and 110, respectfully. LAN 107 may be an Ethernet or token ring network or hub coupled to one or more computers 111, while WAN port 109 may comprise an internal V.90 modem, ADSL remote, ISDN interface, T1/E1, or integrated CSU/DSU (Channel Service Unit/Data Service Unit), or some other type of wide area network. Such a wide area network 112 may be the Internet, an intranet, a Virtual Private Network (VPN), etc.

Information stored on a smart card 120 can be used for distribution of encryption keys, storage of basic router configuration information, authorization for configuring the router 100, an authorization for use of the router (if the smart card 120 is not inserted into the smart card device 102, the router 100 does not process data traffic between LAN 107 and WAN 112). The smart card can be inserted and removed while the router 100 is powered on (i.e., hot-pluggable).

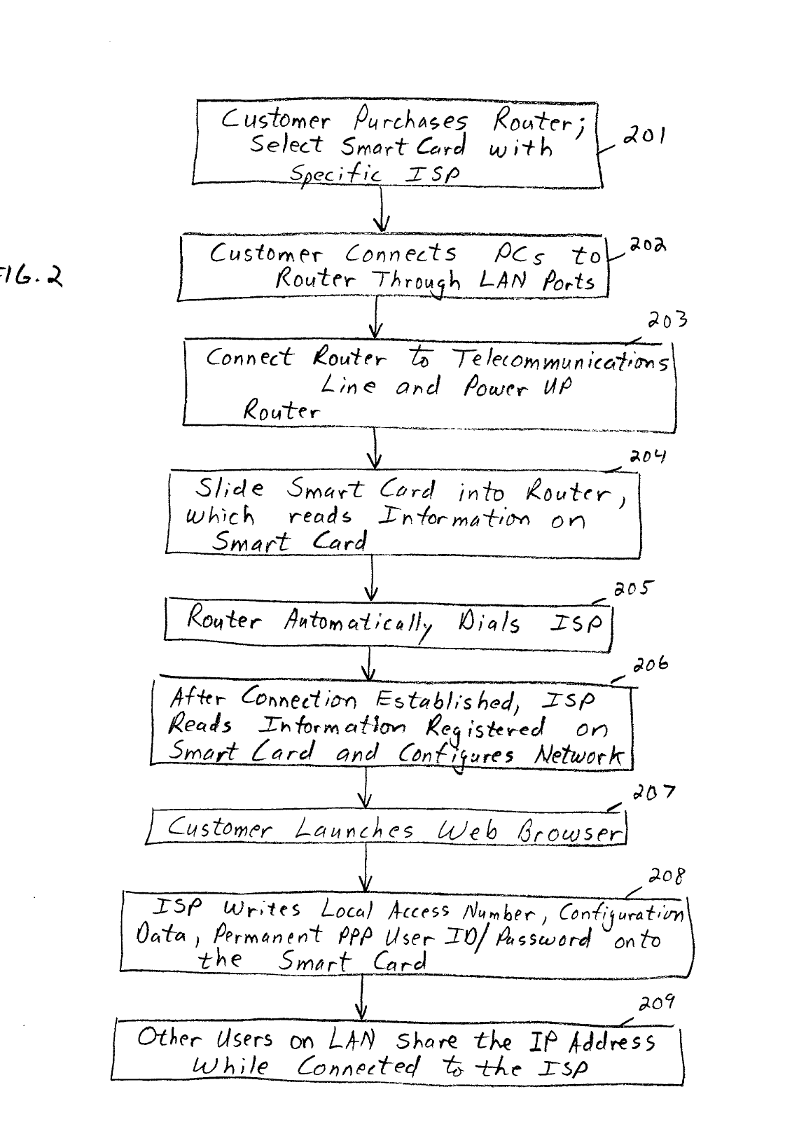

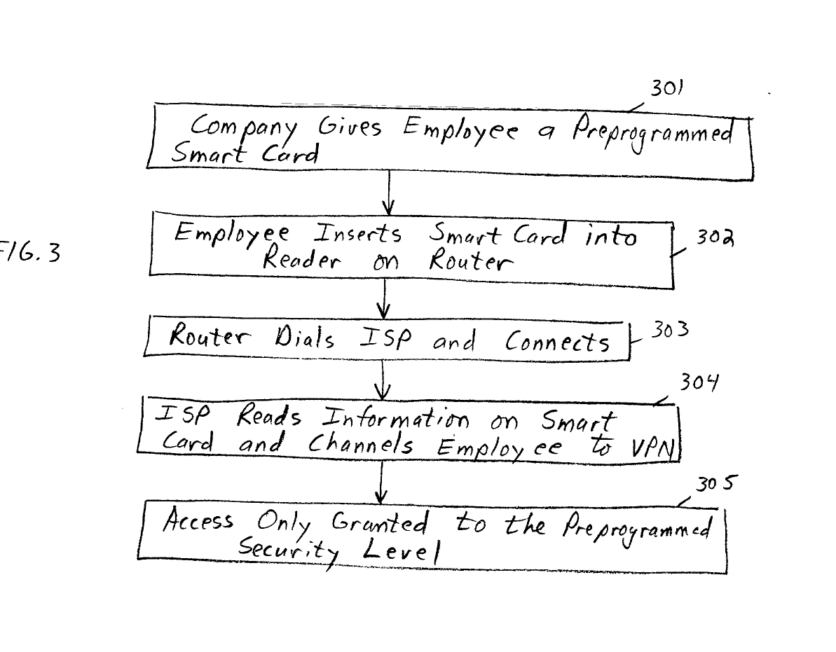

Referring to FIG. 2, there is illustrated a process for using a smart card 120 in router 100 for implementing the use of the router 100 to access the Internet. In step 201, when a customer buys a router 100, the customer can choose a smart card 120 from a specific ISP vendor. In step 202, the customer will then connect the customer's computers or web devices 111 to the router 100 through LAN ports 107. In step 203, the customer will then connect the router 100 through the WAN port 109 to a telecommunications line 121 to access a WAN 112. The customer will then power up the router 100 and the computers or web devices 111. In step 204, the customer will slide or insert the smart card 120 into the smart card device 102 coupled to the router 100, which reads information stored on the smart card 120. In step 205, the router 100 will then proceed to automatically dial the ISP's phone number, such as a toll free telephone number, In step 206, after being connected, the data processing system associated with the ISP (not shown) will read information registered on the smart card 120 and then configure the networking parameters for the connection to the ISP. In step 207, the customer can then launch the customer's web browser program, and type in the customer's proffered ID and password. In step 208, the ISP can then write the local access phone number, present configuration data, permanent PPP (Point-To-Point), and user ID/password onto the smart card 120 through the router 100 and the smart card device 102. Thereafter, in step 209, other users using their computers or web devices 111 on the LAN 107 can share the dynamically assigned IP (Internet Protocol) address while connected to the ISP through the WAN 112.

Note the ISP can also log other information onto the smart card 120 for statistical study, billing, or fixture functional expansions.

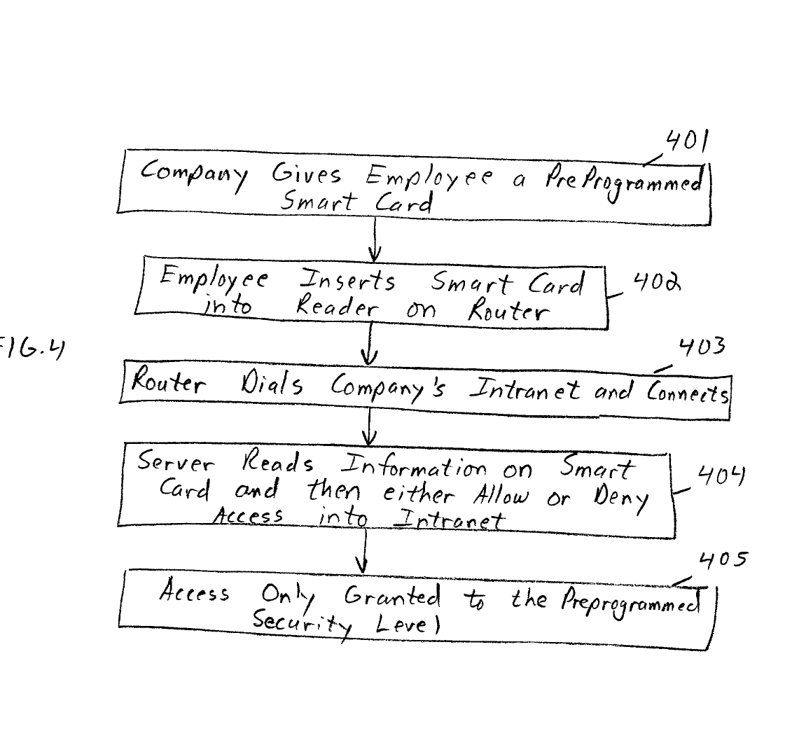

Referring next to FIG. 3, there is illustrated an alternative embodiment for use of the smart card and router of the present invention for accessing a Virtual Private Network (VPN). In step 301, an employer or company can provide a pre-programmed smart 120 to an employee, wherein the smart card will include a phone number for accessing a specified ISP, including other configuration data, an encryption key, an ID/password, a specified security level granted to the employee, and any other necessary data. In step 302, the employee can then at their home office slide the smart card 120 into their router 100. In step 303, the router 100 will dial up and connect to the ISP. In step 304, the ISP will read the information on the smart card 120 and channel the user to a VPN specified by the employer. In step 305, a security level preprogrammed onto the smart card 120 can be implemented so that the employee is only able to access the VPN at a specified security level.

In FIG. 4, there is illustrated another alternative embodiment of the present invention for use of a smartcard and router for gaining access to an intranet. In step 401, a company or an employer can give an employee a pre-programmed smart card 120 with the intranet access phone number, configuration data, an encryption key, an ID/password, a specified security level, and any other necessary data. In step 402, the employee can then insert the smart card 120 into their router 100. In step 403, the router 100 dials up the company's intranet and connects to it. In step 404, when connected, the server associated with the intranet accessed using the intranet access phone number will read information on the smart card 120 and then either allow or prohibit the user to have access into the company's intranet. In step 405, in accordance with a security level pre-programmed onto the smart card, the employee can only have access to a specified security level.

Although the present invention and its advantages have been described in detail, it should be understood that various changes, substitutions and alterations can be made herein without departing from the spirit and scope of the invention as defined by the appended claims.

What is claimed is:

1. A network router comprising:
a processor;
a port operable for coupling the processor to a WAN;
a port operable for coupling the processor to a LAN;
a smart card reader coupled to the processor;
circuitry operable for reading data from a smart card inserted into the smart card reader, wherein the data includes information on how to dial up a data processing system over the WAN; and
circuitry operable for dialing up the data processing system over the WAN using the information.

2. The network router as recited in claim 1, wherein the data processing system is associated with an ISP, and wherein the information includes the phone number of the ISP.

3. The network router as recited in claim 2, wherein the data includes networking parameters read by the ISP to configure a connection between the router and the data processing system.

4. The network router as recited in claim 2, further comprising:
circuitry operable for receiving from the data processing system over the WAN configuration information; and
circuitry operable for writing the configuration information onto the smart card via the smart card reader.

5. The network router as recited in claim 4, wherein the configuration information includes a PPP user ID and password.

6. The network router as recited in claim 4, wherein the configuration information includes a local phone number for dialing up the ISP.

7. The network router as recited in claim 5, further comprising:
circuitry operable for permitting a plurality of computers coupled to the router via the LAN to access the ISP using the configuration information.

8. The network router as recited in claim 1, further comprising:
circuitry operable for establishing a connection between the router and the data processing system; and
circuitry operable for channeling the connection to a specified virtual private network.

9. The network router as recited in claim 8, further comprising:
circuitry operable for permitting access on the virtual private network only at a security level specified in the information on the smart card.

10. The network router as recited in claim 1, wherein the WAN is an Intranet.

11. The network router as recited in claim 10, further comprising:
circuitry operable for permitting access to the Intranet as a function of security information stored on the smart card.

12. A network router comprising:
a processing means;
means for coupling the processing means to a WAN;
means for coupling the processing means to a LAN;
means for reading and writing a smart card coupled to the processing means;
means for reading data from the smart card inserted into the smart card reading means, wherein the data includes information on how to dial up a data processing system over the WAN; and
means for dialing up the data processing system over the WAN using the information.

13. The network router as recited in claim 12, wherein the data processing system is associated with an ISP, and wherein the information includes the phone number of the ISP.

14. The network router as recited in claim 13, wherein the data includes networking parameters read by the ISP to configure a connection between the router and the data processing system.

15. The network router as recited in claim 13, further comprising:
means for receiving from the data processing system over the WAN configuration information; and
means for writing the configuration information onto the smart card via the smart card writing means.

16. The network router as recited in claim 15, wherein the configuration information includes a PPP user ID and password.

17. The network router as recited in claim 15, wherein the configuration information includes a local phone number for dialing up the ISP.

18. The network router as recited in claim 16, further comprising:
means for permitting a plurality of computers coupled to the router via the LAN to access the ISP using the configuration information.

19. The network router as recited in claim 12, further comprising:
means for establishing a connection between the router and the data processing system; and
means for channeling the connection to a specified virtual private network.

20. The network router as recited in claim 19, further comprising:
means for permitting access on the virtual private network only at a security level specified in the information on the smart card.

21. The network router as recited in claim 12, wherein the WAN is an Intranet.

22. The network router as recited in claim 21, further comprising:
means for permitting access to the Intranet as a function of security information stored on the smart card.

23. A method for using a network router comprising the steps of:
inserting a smart card into a smart card reader coupled to a processor in the router;
reading data from the smart card inserted into the smart card reader, wherein the data includes information on how to dial up a data processing system over a WAN; and
dialing up the data processing system over the WAN using the information.

24. The method as recited in claim 23, wherein the data processing system is associated with an ISP, and wherein the information includes the phone number of the ISP.

25. The method as recited in claim 24, wherein the data includes networking parameters read by the ISP to configure a connection between the router and the data processing system.

26. The method as recited in claim 24, further comprising the step of:
receiving configuration information from the data processing system over the WAN; and
writing the configuration information onto the smart card.

27. The method as recited in claim 26, wherein the configuration information includes a PTP user ID and password.

28. The method as recited in claim 26, wherein the configuration information includes a local phone number for dialing up the ISP.

29. The method as recited in claim 27, further comprising the step of:
permitting a plurality of computers coupled to the router via the LAN to access the ISP using the configuration information.

30. The method as recited in claim 23, further comprising the steps of:
establishing a connection between the router and the data processing system; and
channeling the connection to a specified virtual private network.

31. The method as recited in claim 30, further comprising the step of:
permitting access on the virtual private network only at a security level specified in the information on the smart card.

32. The method as recited in claim 23, wherein the WAN is an Intranet.

33. The method as recited in claim 32, further comprising the step of:
permitting access to the Intranet as a function of security information stored on the smart card.

34. A smart card adaptable for inserting into a smart card reader coupled to a processor in a network router, the smart card comprising data stored on the smart card that includes information usable by the network router on how to dial up a data processing system over a WAN.

35. The smart card as recited in claim 34, wherein the data processing system is associated with an ISP, and wherein the information includes the phone number of the ISP.

36. The smart card as recited in claim 35, wherein the data includes networking parameters read by the ISP to configure a connection between the router and the data processing system.

37. The smart card as recited in claim 35, further comprising circuitry operable for receiving and storing configuration information onto the smart card.

38. The smart card as recited in claim 37, wherein the configuration information includes a PPP user ID and password.

39. The smart card as recited in claim 37, wherein the configuration information includes a local phone number for dialing up the ISP.

40. The smart card as recited in claim 34, further comprising:
data stored on the smart card for establishing a connection between the router and the data processing system; and
data stored on the smart card for channeling the connection to a specified virtual private network.

41. The smart card as recited in claim 40, further comprising:
data stored on the smart card for permitting access on the virtual private network only at a security level specified in the information on the smart card.

42. The smart card as recited in claim 34, wherein the WAN is an Intranet.

43. The smart card as recited in claim 42, further comprising:
data stored on the smart card for permitting access to the Intranet as a function of security information stored on the smart card.
